(19) United States
(12) Patent Application Publication
(10) Pub. No.: US 2019/0106574 A1
(43) Pub. Date: Apr. 11, 2019

(54) COATING AGENT FOR FORMING METAL OXIDE FILM AND METHOD FOR PRODUCING SUBSTRATE HAVING METAL OXIDE FILM

(71) Applicants: TOKYO OHKA KOGYO CO., LTD., Kawasaki-shi (JP); JCU CORPORATION, Tokyo (JP)

(72) Inventors: Koichi MISUMI, Kawasaki-shi (JP); Christopher CORDONIER, Kawasaki-shi (JP)

(21) Appl. No.: 16/089,080

(22) PCT Filed: Mar. 29, 2017
(86) PCT No.: PCT/JP2017/013029

§ 371 Date: Sep. 27, 2018

(30) Foreign Application Priority Data
Mar. 30, 2016 (JP) 2016-068800

(51) Int. Cl. C09D 1/00; C09D 7/20; C01G 23/00; C23C 18/38

(52) U.S. Cl. CPC C09D 1/00; C23C 18/38; C01G 23/003; C09D 7/20

(57) ABSTRACT

A coating agent for forming a metal oxide film, which contains an organic solvent that is different from N,N-dimethyl acetamide (DMA) or N-methyl pyrrolidone (NMP), and which has excellent conformal coating properties; and a method for producing a substrate having a metal oxide film. A coating agent for forming a metal oxide film, which contains a solvent and a metal, and wherein the solvent contains a compound (A) represented by formula (1).

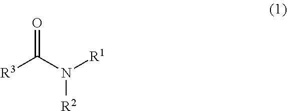

In formula (1), each of R¹ and R² independently represents an alkyl group having 1-3 carbon atoms; and R³ represents a group represented by formula (1-1) or formula (1-2).

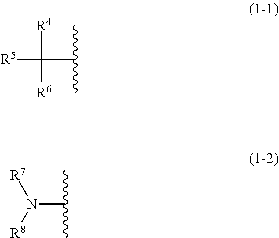

In formula (1-1), R⁴ represents a hydrogen atom or a hydroxyl group; and each of R⁵ and R⁶ independently represents an alkyl group having 1-3 carbon atoms. In formula (1-2), each of R⁷ and R⁸ independently represents a hydrogen atom or an alkyl group having 1-3 carbon atoms.

### TECHNICAL FIELD

The present invention relates to a coating agent for forming a metal oxide film and a method for producing a substrate having a metal oxide film.

### BACKGROUND ART

Heretofore, a metal oxide film has been used for electronic equipment, etc. such as liquid crystal displays, and when this metal oxide film is formed, an organic solvent has been used. The organic solvent is used after being appropriately selected according to the application, and, for example, N,N-dimethyl acetamide (DMA), N-methyl pyrrolidone (NMP), and the like have been known as the organic solvent (see Patent Documents 1 and 2).
Patent Document 1: Japanese Unexamined Patent Application, Publication No. 2011-207693
Patent Document 2: Japanese Patent No. 5694265

### DISCLOSURE OF THE INVENTION

### Problems to be Solved by the Invention

Recently, environmentally conscious procurement and design have been required throughout the world, and use of materials that are environmentally friendly and safer has been desired. For example, in Europe, the directive on restriction of the use of certain hazardous substances in electrical and electronic equipment (RoHS Directive) has been enforced.

In the RoHS Directive, hazardous substances such as Pb are subjected to regulation, and recently, response to the REACH regulation in addition to the RoHS Directive has been required. In the REACH regulation, substances including substances of very high concern (SVHCs) are subjected to regulation, and, for example, DMA, the above-mentioned organic solvent, is also listed as a substance which is subjected to regulation. Therefore, it is imperative to develop and commercialize organic solvents which are not subjected to environmental regulation, such as DMA.

Furthermore, when, for example, NMP is used as an alternative to DMA, which is the above-mentioned organic solvent, there was a problem in which conformal coating as in the case of DMA was impossible depending on the shape of a substrate to be coated.

Therefore, the objective of the present invention is to provide a coating agent for forming a metal oxide film, which contains an organic solvent that is different from N,N-dimethyl acetamide (DMA) or N-methyl pyrrolidone (NMP), and which has excellent conformal coating properties, and a method for producing a substrate having a metal oxide film.

### Means for Solving the Problems

In view of the above problems, the present inventors have intensively studied the problem. As a result, the present inventors completed the present invention of the following (1) to (9), which is related to a coating agent for forming a metal oxide film, which contains an organic solvent that is different from DMA or NMP, and which has excellent conformal coating properties to a substrate, and a method for producing a substrate having a metal oxide film.
(1) A coating agent for forming a metal oxide film, comprising a solvent and a metal, wherein the solvent contains a compound (A) represented by the following formula (1):

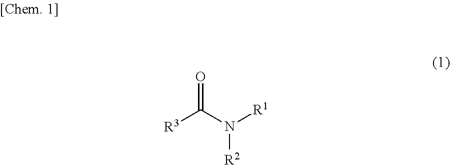

wherein, in formula (1), R¹ and R² each independently represent an alkyl group having 1 to 3 carbon atoms; and R³ represents a group represented by the following formula (1-1) or the following formula (1-2):

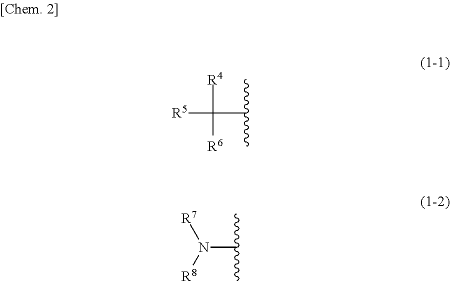

wherein, in formula (1-1), R⁴ represents a hydrogen atom or a hydroxyl group; and R⁵ and R⁶ each independently represent an alkyl group having 1 to 3 carbon atoms.
wherein, in formula (1-2), R⁷ and R⁸ each independently represent a hydrogen atom or an alkyl group having 1 to 3 carbon atoms.
(2) A coating agent for forming a metal oxide film, including a solvent and a metal, wherein the boiling point of the solvent is 150 to 190° C., the surface tension at 20° C. is 25 to 35 mN/m, and the vapor pressure at 100° C. is 5 to 15 kPa.
(3) The coating agent according to (1) or (2), wherein the metal is a metal having conductivity.
(4) The coating agent according to any one of (1) to (3), which includes a ligand compound.
(5) The coating agent according to any one of (1) to (4), which includes a photosensitive compound.
(6) The coating agent according to any one of (1) to (5), wherein the compound (A) is N,N,2-trimethylpropionamide or N,N,N′,N′-tetramethylurea.
(7) A method for producing a substrate having a metal oxide film, which include the step of coating the coating agent according to any one of (1) to (6) on a substrate and heating to form a metal oxide film.
(8) The production method according to (7), wherein the substrate includes an interposer substrate with micron scale holes and the micron scale hole surfaces are covered with a metal oxide film.
(9) The production method according to (7), which is used for production of a plated substrate.

### Effects of the Invention

According to the present invention, it is possible to provide a coating agent for forming a metal oxide film, which contains an organic solvent that is different from N,N-dimethyl acetamide (DMA) or N-methyl pyrrolidone (NMP), and which has excellent conformal coating properties, and a method for producing a substrate having a metal oxide film.

### BRIEF DESCRIPTION OF THE DRAWINGS

FIG. 1 is a flow chart showing a method for forming a metal oxide film according to the first embodiment.

FIG. 2 is a section view for explaining a method for forming a metal oxide film according to the first embodiment.

FIG. 3 is a flow chart showing a method for forming a metal oxide film pattern according to the second embodiment.

FIG. 4 is a section view for explaining a method for forming a metal oxide film pattern according to the second embodiment.

FIG. 5 is a flow chart showing a method for forming electroless plating according to the third embodiment.

FIG. 6 is a section view for explaining a method for forming electroless plating according to the third embodiment.

FIG. 7 is a flow chart showing a method for forming an electroless plating pattern according to the fourth embodiment.

FIG. 8 is a section view for explaining an electroless plating pattern according to the fourth embodiment.

FIG. 9 is a flow chart showing a variation of a method for forming an electroless plating pattern according to the fourth embodiment.

FIG. 10 is a photomicrograph showing that a substrate and a through substrate hole processed glass were coated with a coating agent for forming a metal oxide film according to Example 1.

FIG. 11 is a photomicrograph showing that a substrate was coated with a coating agent for forming a metal oxide film according to Comparative Example 1.

### PREFERRED MODE FOR CARRYING OUT THE INVENTION

Embodiments of the present invention will be described below, but the present invention is not interpreted in a limited way by the following descriptions.

### (Coating Agent for Forming Metal Oxide Film)

A coating agent for forming a metal oxide film according to this embodiment is a coating agent for forming a metal oxide film, including a solvent and a metal, wherein the solvent contains a compound (A) represented by the following formula (1). This coating agent for forming a metal oxide film is sometimes referred to as “catalytic solution” (solution for forming a catalyst precursor film) when an electroless plating film is formed.

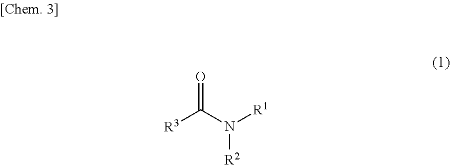

In formula (1), R¹ and R² each independently represent an alkyl group having 1 to 3 carbon atoms; and R³ represents a group represented by the following formula (1-1) or the following formula (1-2):

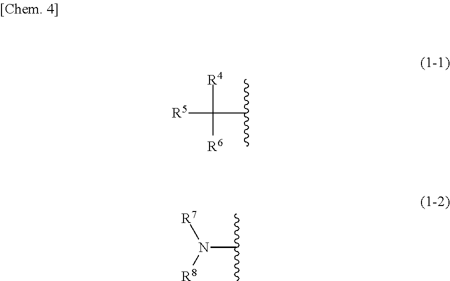

In formula (1-1), R⁴ represents a hydrogen atom or a hydroxyl group; and R⁵ and R⁶ each independently represent an alkyl group having 1 to 3 carbon atoms. In formula (1-2), R⁷ and R⁸ each independently represent a hydrogen atom or an alkyl group having 1 to 3 carbon atoms.

Specific examples of a compound (A) represented by formula (1), wherein R³ is a group represented by formula (1-1), include N,N,2-trimethylpropionamide (DMIB), N-ethyl,N,2-dimethylpropionamide, N,N-diethyl-2-methylpropionamide, N,N,2-trimethyl-2-hydroxypropionamide, N-ethyl-N,2-dimethyl-2-hydroxypropionamide, and N,N-diethyl-2-hydroxy-2-methylpropionamide.

Specific examples of a compound (A) represented by formula (1), wherein R³ is a group represented by formula (1-2), include N,N,N′,N′-tetramethylurea (TMU) and N,N,N′,N′-tetraethylurea.

Of the above-mentioned examples of a compound (A), examples of a particularly preferable compound in terms of conformality include N,N,2-trimethylpropionamide and N,N,N′,N′-tetramethylurea.

The above-mentioned compound (A) represented by formula (1) is characterized by a lower boiling point than that of NMP. Due to a lower boiling point than that of NMP, evaporation is likely to occur at a lower temperature, and a conformal film tends to be formed. Due to a higher boiling point than a predetermined temperature, a film is likely to be smoothened before cured, and a conformal film tends to be formed. The boiling point of the compound (A) is preferably 150 to 190° C., more preferably 160 to 190° C., and still more preferably 170 to 180° C. For example, the boiling point of N,N,2-trimethylpropionamide under atmospheric pressure is 175° C., and the boiling point of N,N,N′,N′-tetramethylurea under atmospheric pressure is 177° C.

The above-mentioned compound (A) represented by formula (1) is characterized by a low surface tension. Due to a low surface tension, the wettability is improved, and a conformal film tends to be formed. The surface tension of the compound (A) at 20° C. is preferably 25 to 35 mN/m, more preferably 27 to 35 mN/m, and still more preferably 30 to 35 mN/m. For example, the surface tension of N,N,2-trimethylpropionamide at 20° C. is 31.9 mN/m, and the surface tension of N,N,N′,N′-tetramethylurea at 20° C. is 34.4 mN/m.

The above-mentioned compound (A) represented by formula (1) is characterized by a high vapor pressure. Due to a high vapor pressure, a conformal film tends to be formed. The vapor pressure of the compound (A) at 100° C. is preferably 5 to 15 kPa, more preferably 6 to 15 kPa, and still more preferably 7 to 15 kPa. For example, the vapor pressure of N,N,2-trimethylpropionamide at 100° C. is 9 kPa, and the vapor pressure of N,N,N′,N′-tetramethylurea at 100° C. is 13.3 kPa.

There is no particular limitation on the content of the above-mentioned compound (A) in a solvent used for preparation of a coating agent for forming a metal oxide film according to this embodiment, in a range such that the objective of the present invention is not impeded. The ratio of the compound (A) to the mass of the solvent is typically preferably 4 percent by mass or more, more preferably 10 percent by mass or more, and particularly preferably 20 percent by mass or more. There is no particular limitation on the upper limit, and the content of the compound (A) may be 100 percent by mass, and for example, the content is 99 percent by mass or less.

Examples of an organic solvent that can be used together with the compound (A) include nitrogen-containing polar solvents such as N,N-dimethylformamide, N,N-dimethylacetamide, N-methyl-2-pyrrolidone, hexamethylphosphoramide, and 1,3-dimethyl-2-imidazolidinone; ketones such as methyl ethyl ketone, methyl isobutyl ketone, cyclohexanone, and isophorone; esters such as γ-butyrolactone, γ-valerolactone, δ-valerolactone, γ-caprolactone, ε-caprolactone, α-methyl-γ-butyrolactone, ethyl lactate, methyl acetate, ethyl acetate, and n-butyl acetate; cyclic ethers such as dioxane and tetrahydrofuran; cyclic esters such as ethylene carbonate and propylene carbonate; aromatic hydrocarbons such as toluene and xylene; and sulfoxides such as dimethyl sulfoxide.

The coating agent for forming a metal oxide film according to this embodiment may be a coating agent for forming a metal oxide film, which contains a solvent and a metal, and wherein the boiling point of the solvent is 150 to 190° C., the surface tension of the solvent is 25 to 35 mN/m, and the vapor pressure of the solvent at 100° C. is 5 to 15 kPa. As mentioned above, it is excellent in terms of the fact that a coating film can be formed conformally when the boiling point, surface tension, and the vapor pressure of the solvent are within the above range. Particularly, a conformal film can be formed to a substrate having a micron scale hole on the surface thereof.

In the coating agent for forming a metal oxide film according to this embodiment, the metal may be different depending on the case in which a metal oxide film is formed and the case in which further an electroless plating film, etc. is formed, as mentioned below. Plural metals may be used.

As the metal, for example, B, Al, Ga, In, Tl, Si, Ge, Sn, Pb, Po, Sb, Bi, Sr, Ba, Sc, Y, Ti, Zr, Hf, Nb, Ta, V, Cr, Mo, W, Mn, Fe, Ru, Co, Rh, Ni, Pd, Pt, Cu, Au, Zn, Cd, La, Ce, Pr, Nd, Sm, Eu, Gd, Tb, Dy, Ho, Er, Tm, Yb, Lu, and the like can be used. The metal is preferably a metal having conductivity. For example, when In or Sn is contained as the metal, an ITO electrode can be formed by using the coating agent for forming a metal oxide film according to this embodiment.

There is no particular limitation on the content of the metal in the coating agent, but examples thereof include a concentration of 1 mmol/L to 1 mol/L, and the concentration is preferably 10 mmol/L to 700 mmol/L and more preferably 50 mmol/L to 500 mmol/L.

The coating agent for forming a metal oxide film according to this embodiment preferably contains a ligand compound. There is no particular limitation on the ligand compound as long as it can form a metal complex by reacting with a metal (metal ion), and for example, a 4-(2-nitrobenzyloxycarbonyl)catechol ligand (formula (10) as mentioned below) and a 4-(4,5-dimethoxy-2-nitrobenzyloxycarbonyl)catechol ligand (formula (11) as mentioned below) can be used. A ligand compound such as ethyl protocatechuate, 4-cyanocatechol, and 4-methylcatechol can also be used.

The coating agent for forming a metal oxide film according to this embodiment preferably contains a metal complex. As the metal complex, for example, a compound represented by the following formula (2) or formula (3) is preferably used.

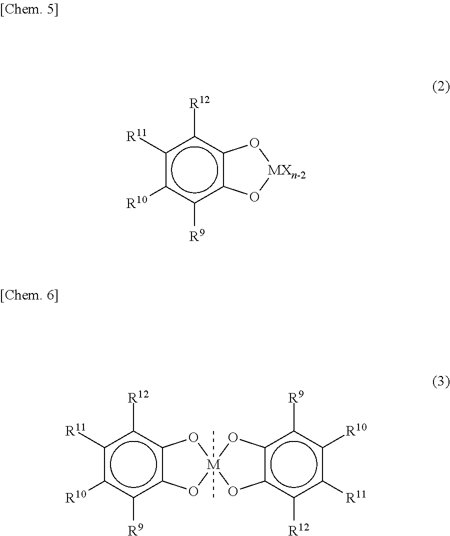

In formula (2) and formula (3), M represents a metal atom, and n represents an integer of 2 or more.

n is preferably an integer of 2 to 10, more preferably an integer of 2 to 6, and still more preferably an integer of 3 to 4.

X in formula (2) is selected from any of the following (d1) to (d10):
(d1) hydroxide or alkoxide (for example, ethylene glycol, 1,2-hexanediol, a catechol derivative, an ethoxy group, a butoxy group, a methoxyethoxy group, a-hydroxyketones (cyclotene, maltol))
(d2) carboxylate (for example, formate (hereinafter, “salt (-ate)” refers to a salt formed as “MX,2”), acetate, oxalate, ethylhexanoate, methoxyacetate, 2-methoxyethoxyacetate) (d3) β-ketonate (acetylacetonate)
(d4) an organic moiety covalently bound to a metal
(d5) hydrofluoride, hydrochloride, oxalate, iodate
(d6) nitrate or nitrite
(d7) sulfate or sulfite
(d8) perchlorate or hypochlorite
(d9) phosphate
(d10) borate

At least one of R⁹ to R¹² in formula (2) and formula (3) is any of formula (4) to formula (7).

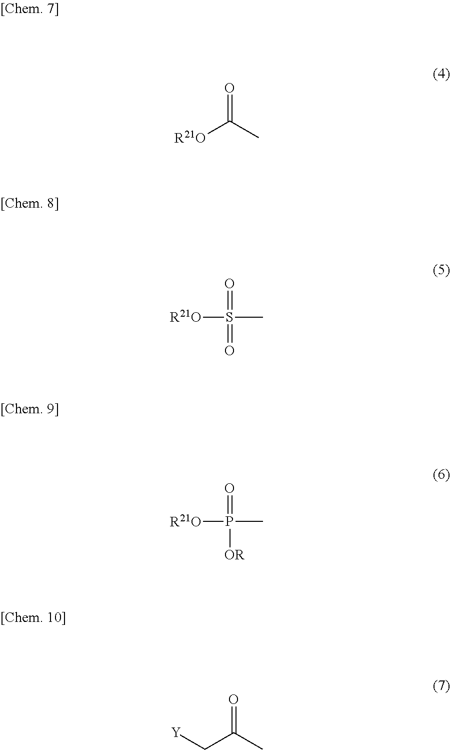

R²¹ in formulas (4) to (6) is formula (8) or formula (9).

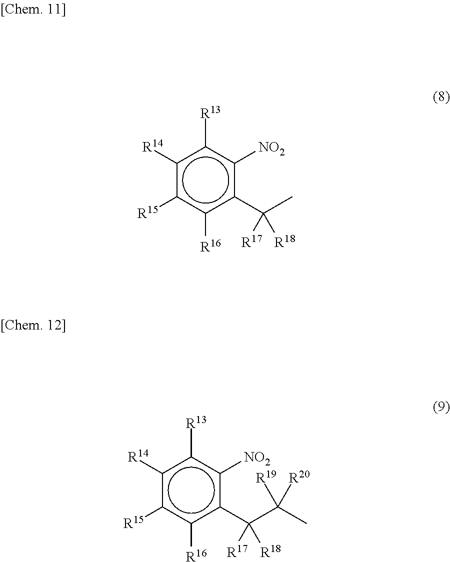

R⁹ to R¹² in formula (2) or formula (3) which are not any of formula (4) to formula (7) and R¹³ to R¹⁶ in formula (8) to formula (9) each are any of the following (al) to (a14):
(a1) H
(a2) a C1 to C20 saturated or unsaturated alkyl group, which is represented by CₙH₂ₙ₊₁ or CₙH₂ₙ₋₁₋₂ₓ, wherein n is 1 to 20 and x is 0 to n−1
(a3) an alkylamine group (alkylamino group)
(a4) a carbinol group
(a5) an aldehyde group (for example, a formyl group) or a ketone group (for example, an alkylcarbonyl group)
(a6) which is represented by COOR, wherein R is CₘH₂ₘ₊₁ or CₘH_{2m-1-2y} (m is 0 to 20, y is 0 to m−1)
(a7) F, Cl, Br, or I
(a8) CN or NO₂
(a9) a hydroxy group or ethers (for example, an alkoxy group)
(a10) amines (an amino group)
(a11) amides (for example, an aminocarbonyl group)
(a12) a thio group or thioethers (for example, an alkylthio group)
(a13) phosphines (for example, a phosphinyl group) or a phosphate group
(a14) a cyclic group, a benzo(phenyl group), an azole group, an oxazole group, a thiazole group, or a dioxole group

Y in formula (7) is any of the following (b1) to (b5):
(b1) F, Cl, Br, or I
(b2) an oxocarbonyl group or CH₃COO—
(b3) an amide group or CH₃CONH—
(b4) a sulfonyl group or CH₃SO₃—
(b5) a phosphoryloxy group or Ph₂POO—

R¹⁷ to R¹⁸ in formula (8) and R¹⁷ to R²⁰ in formula (9) each are any of the following (c1) to (c15):
(c1) H
(c2) a C1 to C20 saturated or unsaturated alkyl group, which is represented by CₙH₂ₙ₊₁ or CₙH₂ₙ₋₁₋₂, wherein n is 1 to 20 and x is 0 to n−1
(c3) a carbinol group
(c4) an aldehyde group (for example, a formyl group) or a ketone group (for example, an alkylcarbonyl group)
(c5) which is represented by COOR, wherein R is CₘH₂ₘ₊₁ or CₘH_{2m-1-2y} is 0 to 20 and y is 0 to m−1)
(c6) F, Cl, Br, or I
(c7) CN or NO₂
(c8) a hydroxy group or ethers (for example, an alkoxy group)
(c9) amines (an amino group)
(c10) amides (for example, an aminocarbonyl group)
(c11) a thio group or thioethers (for example, an alkylthio group)
(c12) a phosphinyl group or a phosphate group
(c13) a cyclic group, a benzo(phenyl group), an azole group, an oxazole group, a thiazole group, or a dioxole group
(c14) an alkylamino group
(c15) a group including a 2-nitrobenzyl structure

A Specific example of a combination of a positive-type first metal complex and a second metal complex is a combination of NBOC-CAT (a complex of formula (10) and a first metal (for example, formula (12) and formula (13)) and NVOC-CAT (a complex of formula (11) and a second metal).

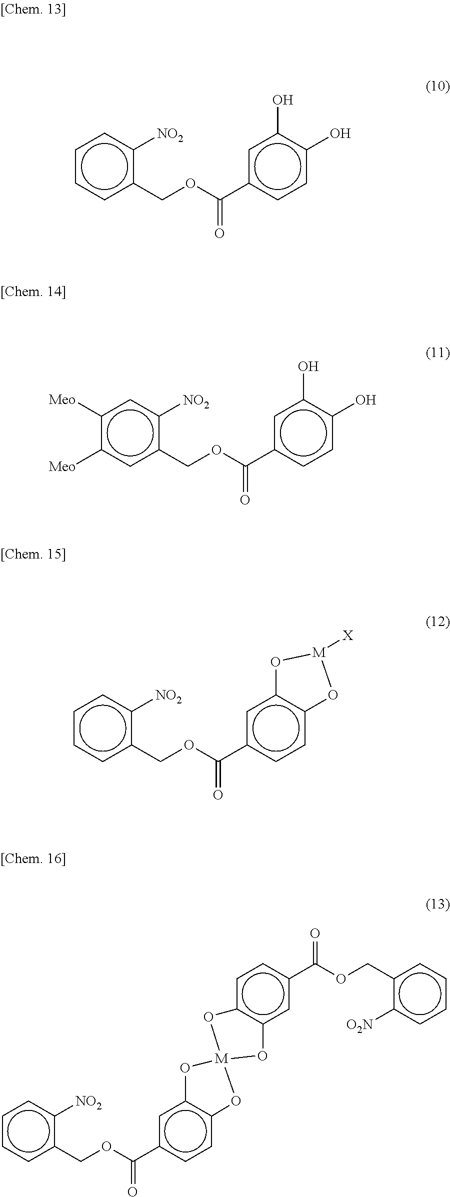

The reason that a metal complex represented by formula (2) or formula (3) is insoluble in a developing solution before exposure, but becomes easily soluble by exposure using light at a predetermined wavelength can be assumed as follows. A metal complex represented by formula (2) or formula (3) has a structure in which a 2-nitrobenzyl alcohol derivative is bound by an ester bond. This metal complex is insoluble in a developing solution (particularly an alkaline developing solution). In the exposure step, when a coating film including this metal complex is irradiated with ultraviolet rays such that the moiety of the 2-nitrobenzyl alcohol derivative is absorbed, the ester bond is broken and 2-nitrosobenzaldehyde and a carboxycatechol derivative-metal complex are produced. This carboxycatechol derivative-metal complex becomes easily soluble in an alkaline developing solution due to a carboxyl group produced by breakage of the ester bond. Therefore, a metal complex represented by formula (2) or formula (3) is insoluble in an alkaline developing solution before exposure, but becomes easily soluble by exposure using light at a predetermined wavelength.

When a metal complex represented by formula (2) or formula (3) is used, a high-contrast pattern is obtained. The reason can be assumed as follows. In other words, since a carboxycatechol derivative-metal complex produced in the exposed moiety is chemically stable and does not become insoluble, etc. due to polymerization between complexes does not occur, a pattern with a higher contrast than that of a conventional complex in which a metal hydroxide is released is easily obtained. When a metal complex represented by formula (2) or formula (3) is used, cracking is unlikely to occur in a metal oxide film pattern. Generally, cracking is likely to occur with increase in the film thickness, but when a metal complex represented by formula (2) or formula (3) is used, cracking is unlikely to occur, and thus the film thickness of a film is increased. The reason that cracking is unlikely to occur when a metal complex represented by formula (2) or formula (3) is used can be assumed as follows. In other words, since a benzene ring is likely to be stacked between complexes, a metal complex represented by formula (2) or formula (3) has properties in which the volume contraction in a transverse direction is small during firing and cracking is unlikely to occur.

In a metal complex represented by formula (2) or formula (3), the molar ratio of a ligand (for example, a ligand represented by formula (10) or formula (11)) to the metal is preferably within the range of 0.1 to 2. When this molar ratio is 0.1 or more, the contrast of a pattern is further increased. When this molar ratio is 2 or less, the density of a film after the reduction step is not decreased. The above-mentioned molar ratio is particularly preferably 0.5 to 1, or 2.

Examples of a negative-type complex include a metal complex with a β-diketone-type molecule as a ligand, and a complex having a β-diketone structure can be widely used. Specifically, a complex with acetylacetone (formula (14)) as a ligand and a complex with 1,3-diphenyl-1,3-propanedione (formula (15)) as a ligand can be used.

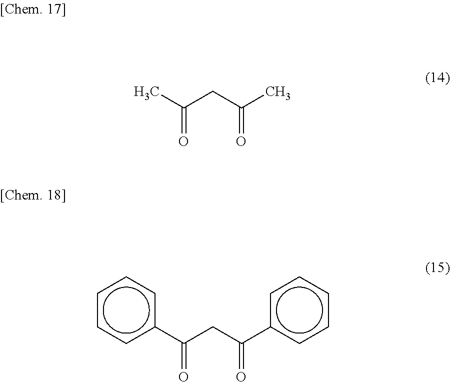

There is no particular limitation on the content of the metal complex in the coating agent, but examples thereof include a concentration of 1 mmol/L to 1 mol/L, and the concentration is preferably 10 mmol/L to 700 mmol/L, and more preferably 50 mmol/L to 500 mmol/L.

The coating agent for forming a metal oxide film according to this embodiment preferably contains a photosensitive compound. Due to containing a photosensitive compound, exposure and development can be performed, and patterning tends to be enabled. There is no particular limitation on the photosensitive compound, and a photosensitive compound that increases the solubility in an alkaline solution of a metal complex component (for example, a tetramethylammonium hydroxide (TMAH) aqueous solution) by irradiation with ultraviolet rays, etc. is preferable, and a quinonediazide group-containing compound is preferable.

Specific examples of the quinonediazide group-containing compound include a completely esterified substance or a partially esterified substance of a phenolic hydroxyl group-containing compound and a naphthoquinonediazide sulfonic acid compound (NQD).

Specific examples of the above-mentioned phenolic hydroxyl group-containing compound include polyhydroxybenzophenones such as 2,3,4-trihydroxybenzophenone and 2,3,4,4′-tetrahydroxybenzophenone;

Trisphenol-type compounds such as tris(4-hydroxyphenyl)methane, bis(4-hydroxy-3-methylphenyl)-2-hydroxyphenylmethane, bis(4-hydroxy-2,3,5-trimethylphenyl)-2-hydroxyphenylmethane, bis(4-hydroxy-3,5-dimethylphenyl)-4-hydroxyphenylmethane, bis(4-hydroxy-3,5-dimethylphenyl)-3-hydroxyphenylmethane, bis(4-hydroxy-3,5-dimethylphenyl)-2-hydroxyphenylmethane, bis(4-hydroxy-2,5-dimethylphenyl)-4-hydroxyphenylmethane, bis(4-hydroxy-2,5-dimethylphenyl)-3-hydroxyphenylmethane, bis(4-hydroxy-2,5-dimethylphenyl)-2-hydroxyphenylmethane, bis(4-hydroxy-3,5-dimethylphenyl)-3,4-dihydroxyphenylmethane, bis(4-hydroxy-2,5-dimethylphenyl)-3,4-dihydroxyphenylmethane, bis(4-hydroxy-2,5-dimethylphenyl)-2,4-dihydroxyphenylmethane, bis(4-hydroxyphenyl)-3-methoxy-4-hydroxyphenylmethane, bis(5-cyclohexyl-4-hydroxy-2-methylphenyl)-4-hydroxyphenylmethane, bis(5-cyclohexyl-4-hydroxy-2-methylphenyl)-3-hydroxyphenylmethane, bis(5-cyclohexyl-4-hydroxy-2-methylphenyl)-2-hydroxyphenylmethane, and bis(5-cyclohexyl-4-hydroxy-2-methylphenyl)-3,4-dihydroxyphenylmethane;

Linear trimer phenol compounds such as 2,4-bis(3,5-dimethyl-4-hydroxybenzyl)-5-hydroxyphenol, and 2,6-bis(2,5-dimethyl-4-hydroxybenzyl)-4-methylphenol;

Linear tetramer phenol compounds such as 1,1-bis[3-(2-hydroxy-5-methylbenzyl)-4-hydroxy-5-cyclohexylphenyl]isopropane, bis[2,5-dimethyl-3-(4-hydroxy-5-methylbenzyl)-4-hydroxyphenyl]methane, bis[2,5-dimethyl-3-(4-hydroxybenzyl)-4-hydroxyphenyl]methane, bis[3-(3,5-dimethyl-4-hydroxybenzyl)-4-hydroxy-5-methylphenyl]methane, bis[3-(3,5-dimethyl-4-hydroxybenzyl)-4-hydroxy-5-ethylphenyl]methane, bis[3-(3,5-diethyl-4-hydroxybenzyl)-4-hydroxy-5-methylphenyl]methane, bis[3-(3,5-diethyl-4-hydroxybenzyl)-4-hydroxy-5-ethylphenyl]methane, bis[2-hydroxy-3-(3,5-dimethyl-4-hydroxybenzyl)-5-methylphenyl]methane, bis[2-hydroxy-3-(2-hydroxy-5-methylbenzyl)-5-methylphenyl]methane, bis[4-hydroxy-3-(2-hydroxy-5-methylbenzyl)-5-methylphenyl]methane, and bis[2,5-dimethyl-3-(2-hydroxy-5-methylbenzyl)-4-hydroxyphenyl]methane;

Linear polyphenol compounds such as linear pentamer phenol compounds such as 2,4-bis[2-hydroxy-3-(4-hydroxybenzyl)-5-methylbenzyl]-6-cyclohexylphenol, 2,4-bis[4-hydroxy-3-(4-hydroxybenzyl)-5-methylbenzyl]-6-cyclohexylphenol, and 2,6-bis[2,5-dimethyl-3-(2-hydroxy-5-methylbenzyl)-4-hydroxybenzyl]-4-methylphenol;

Bisphenol-type compounds such as bis(2,3,-trihydroxyphenyl)methane, bis(2,4-dihydroxyphenyl)methane, 2,3,4-trihydroxyphenyl-4′-hydroxyphenylmethane, 2-(2,3,4-trihydroxyphenyl)-2-(2′,3′,4′-trihydroxyphenyl)propane, 2-(2,4-dihydroxyphenyl)-2-(2′,4′-dihydroxyphenyl)propane, 2-(4-hydroxyphenyl)-2-(4′-hydroxyphenyl)propane, 2-(3-fluoro-4-hydroxyphenyl)-2-(3′-fluoro-4′-hydroxyphenyl)propane, 2-(2,4-dihydroxyphenyl)-2-(4′-hydroxyphenyl)propane, 2-(2,3,4-trihydroxyphenyl)-2-(4′-hydroxyphenyl)propane, 2-(2,3,4-trihydroxyphenyl)-2-(4′-hydroxy-3′,5′-dimethylphenyl)propane, and 4,4′-{1-[4-[2-(4-hydroxyphenyl)-2-propyl]phenyl]ethylidene}bisphenol;

Multimeric branched compounds such as 1-[1-(4-hydroxyphenyl)isopropyl]-4-[1,1-bis(4-hydroxyphenyl)ethyl]benzene and 1-[1-(3-methyl-4-hydroxyphenyl)isopropyl]-4-[1,1-bis(3-methyl-4-hydroxyphenyl)ethyl]benzene; and

condensed phenol compounds such as 1,1-bis(4-hydroxyphenyl)cyclohexane. These can be used alone or two or more compounds can be used in combination.

Examples of the above-mentioned naphthoquinonediazide sulfonic acid compound include naphthoquinone-1,2-diazide-5-sulfonic acid or naphthoquinone-1,2-diazide-4-sulfonic acid.

Nuclear substituted derivatives such as other quinonediazide group-containing compounds, for example, orthobenzoquinonediazide, orthonaphthoquinonediazide, orthoanthraquinonediazide, or orthonaphthoquinonediazide sulfonates, and

further, a product of reaction between orthoquinonediazidesulfonylchloride and a compound having a hydroxyl group or an amino group (for example, phenol, p-methoxyphenol, dimethylphenol, hydroquinone, bisphenol A, naphthol, pyrocatechol, pyrogallol, pyrogallol monomethyl ether, pyrogallol-1,3-dimethyl ether, gallic acid, gallic acid that was esterified or etherified with part of hydroxyl groups remained, aniline, p-aminodiphenylamine, and the like), and the like can also be used. These may be used alone, or two or more compounds may be used in combination.

As the quinonediazide group-containing compound, quinonediazide sulfonate of a compound represented by the following formula (16) or (17) is preferable.

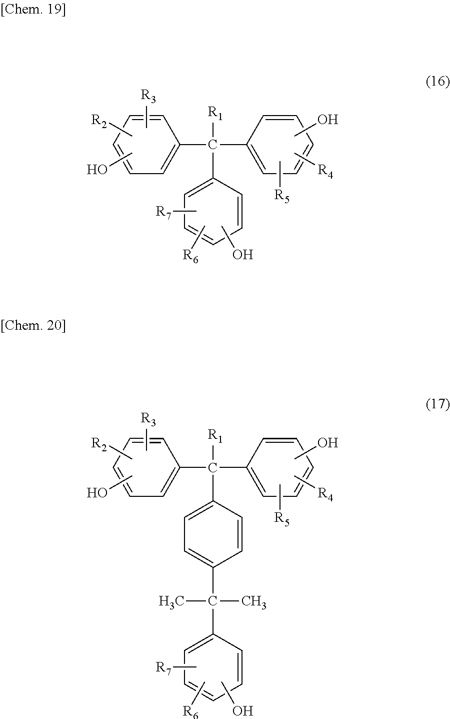

(In formula (16) and (17), R₁, R₂, R₃, R₄, R₅, R₆, and R₇ each independently represent a hydrogen atom, a substituted or unsubstituted alkyl group having 1 to 5 carbon atoms, and a substituted or unsubstituted cycloalkyl group having 4 to 8 carbon atoms.)

Particularly, of quinonediazide sulfonate of a compound represented by formula (16) or (17), quinonediazide sulfonate of a compound represented by the following formula (18) is more preferably used.

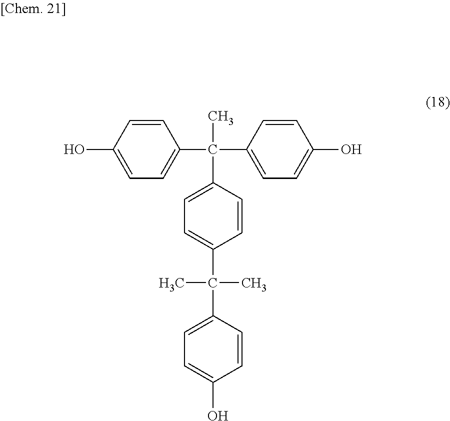 [SMILES: CC(C)(c1ccc(O)cc1)c1ccc(C(C)(c2ccc(O)cc2)c2ccc(O)cc2)cc1]

In the compound represented by formula (16), (17), or formula (18), a naphthoquinone-1,2-diazide-sulfonyl group is preferably one in which a sulfonyl group is bound to the 4-position or the 5-position. These compounds are well dissolved in a solvent which is usually used when the composition is used as a solution, and when they are used as a photosensitive component of a positive-type photoresist composition, a composition which is highly sensitive, excellent in image contrast, a cross-section shape, and heat resistance, as well as which causes no foreign matters when used as a solution is imparted. One or two or more of the quinonediazide sulfonate of a compound represented by formula (16) or (17) may be used. This compound represented by formula (16) can be produced by, for example, condensing 1-hydroxy-4-[1,1-bis(4-hydroxyphenyl)ethyl]benzene and naphthoquinone-1,2-diazide-sulfonyl chloride in a solvent such as dioxane in the presence of an alkali such as triethanolamine, alkaline carbonate, and alkaline bicarbonate to perform complete esterification or partial esterification. This compound represented by formula (17) can be produced by, for example, condensing 1-[1-(4-hydroxyphenyl)isopropyl]-4-[1,1-bis(4-hydroxyphenyl)ethyl]benzene and naphthoquinone-1,2-diazide-sulfonyl chloride in a solvent such as dioxane in the presence of an alkali such as triethanolamine, alkaline carbonate, and alkaline bicarbonate to perform complete esterification or partial esterification. As the naphthoquinone-1,2-diazide-sulfonyl chloride, naphthoquinone-1,2-diazide-4-sulfonyl chloride and naphthoquinone-1,2-diazide-5-sulfonyl chloride are suitable. When the coating agent contains a photosensitive compound, there is no particular limitation on the content of the photosensitive compound, but examples thereof include a concentration of 1 mmol/L to 1 mol/L, and the concentration of 10 mmol/L to 500 mmol/L is preferable, and the concentration of 50 mmol/L to 300 mmol/L is more preferable.

### (Method for Forming Metal Oxide Film)

A method for forming a metal oxide film according to this embodiment includes a step in which the above-mentioned coating agent is coated on a coating object (for example, a substrate), and heated as needed to form a metal oxide film.

### (Method for Using a Coating Agent to Form a Metal Oxide Film)

A use method according to this embodiment is a method for using the above-mentioned coating agent by coating, etc. to form a metal oxide film. [0077]

### (Production Method)

A method for producing a substrate having a metal oxide film according to this embodiment is a production method having a step in which the above-mentioned coating agent is coated on a substrate and heated to form a metal oxide film. This embodiment also relates to a method for producing plating. A method for producing plating according to this embodiment includes a step in which the above-mentioned coating agent is coated on a substrate and heated to form a metal oxide film, and preferably further includes a step of forming a plating film.

The film thickness of the metal oxide film is preferably 10 to 150 nm, more preferably 20 to 100 nm, and still more preferably 30 to 60 nm.

In this embodiment, as the substrate, a substrate such as quartz, glass, silicon wafer, plastic (polycarbonate (PC), polyethylene terephthalate (PET), polyethylene naphthalate (PEN), polyimide (PI), and the like) can be used. The substrate includes an interposer substrate having a micron scale hole on the principal surface of the base, and it is preferable that the pore surface of the micron scale hole is covered with a metal oxide film. As mentioned above, the coating agent for forming a metal oxide film according to this embodiment is characterized by a low boiling point and surface tension and a high vapor pressure. Thus, even for a substrate in which a micron scale hole is formed on the surface thereof, a metal oxide film can be formed conformally.

The method for producing a substrate having a metal oxide film according to this embodiment is preferably used for production of plating. Of such production, it is preferably used for production of electroless plating. In the production of electroless plating, a catalytic material is deposited on the surface of a substrate before formation of a plating film, but by using the method according to this embodiment, it is possible to deposit a catalytic material on the substrate surface and to form an electroless plating film on the catalytic material.

Some methods are considered for formation of an electroless plating film. The first production method to the third production method will be exemplified below.

The first production method for an electroless plating film is, for example, a method for producing plating, which comprises the steps of:
coating a catalytic solution containing an organic compound having the first metal (M1) and a compound having the second metal (M2) on a substrate to form a coating film, heating the coating film to make a catalyst precursor film, reducing the catalyst precursor film to make a catalytic material, and
forming an electroless plating film containing the fourth metal (M4) on the catalytic surface by electroless plating reaction, wherein
the second metal is a metal which is a catalyst in the electroless plating reaction, and
the first metal is a metal which is not a catalyst in the electroless plating reaction and which differs from the second metal.

The second production method for an electroless plating film is, for example, a method for producing plating, which comprises the steps of:
coating a catalytic solution containing an organic compound having the first metal (M1) and a compound having the second metal (M2) on a base to form a coating film,
heating the coating film to make a catalyst precursor film, reducing the catalyst precursor film,
substituting the second metal in the reduced catalyst precursor film by the third metal (M3) to make a catalytic membrane, and
forming an electroless plating film containing the fourth metal (M4) on the catalytic membrane by electroless plating reaction, wherein
the third metal is a metal which is a catalyst in the electroless plating reaction, and
the first metal is a metal which is not a catalyst in the electroless plating reaction and which differs from the second metal and the third metal.

The third production method for an electroless plating film is, for example, a method for producing plating, which comprises the steps of:
coating a catalytic solution containing an organic compound having the first metal (M1) on a substrate to form a coating film,
heating the coating film and imparting the third metal (M3) to make a catalytic surface, and
forming an electroless plating film containing the fourth metal (M4) on the catalytic surface by electroless plating reaction, wherein
the third metal is a metal which is a catalyst in the electroless plating reaction, and
the first metal is a metal which is not a catalyst in the electroless plating reaction and which differs from the third metal.

In the above-mentioned first to third production methods, to perform pattern formation, the catalytic solution preferably contains a ligand compound and a photosensitive compound. Pattern formation is possible by exposing and developing after coating, using a catalytic solution containing a ligand compound and a photosensitive compound as a photosensitive metal complex solution. The photosensitive metal complex solution is preferably coated such that the thickness of the metal oxide film to be formed is 30 nm to 60 nm. Drying after coating of the photosensitive metal complex solution is preferably performed for 5 to 50 minutes, for example, at 100° C. The exposure dose is preferably 100 to 200 mJ/cm² when the thickness of the metal oxide film is 500 nm. Development is preferably performed for 20 to 30 seconds at normal temperature using 0.1 to 0.25% by weight of tetramethylammonium hydroxide (TMAH) or tetraethylammonium hydroxide (TEAH).

This embodiment will be further described by way of drawings.

### First Embodiment

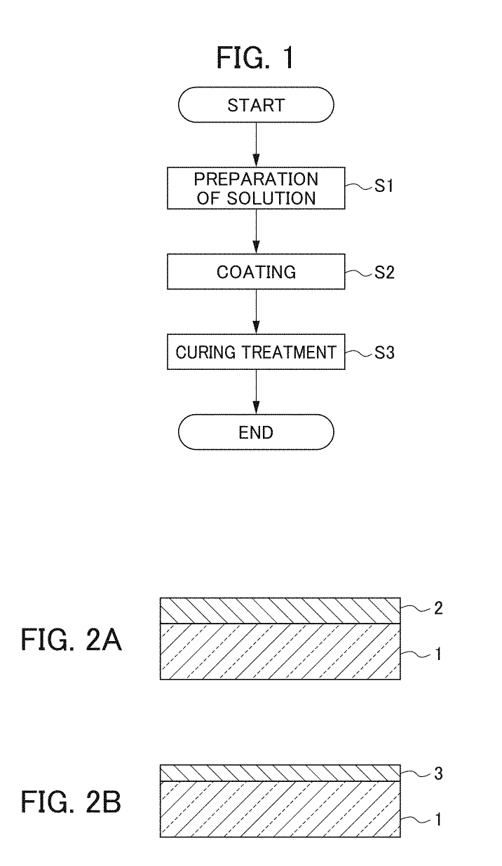

FIG. 1 is a flow chart showing a method for forming a metal oxide film according to the first embodiment. FIG. 2 is a section view for describing a method for forming a metal oxide film according to the first embodiment.

### <Step 1>

In Step 1, a solution which becomes a coating agent is prepared. As the coating agent, a solution containing a solvent and a metal may be prepared. As mentioned above, the solvent is a solvent containing a compound (A) represented by formula (1), and particularly N,N,2-trimethylpropionamide or N,N,N′,N′-tetramethylurea is preferable. The metal is a metal selected from Mg, Ca, Sr, Ba, Sc, Y, La—Lu, Ti, Zr, Hf, Nb, Ta, Mo, W, Zn, Al, In, Si, Ge, Sn, Cu, Fe, Co, Ni, Pd, Au, or Pt, or the like, and an organic compound including a metal may be used.

By Step 1, a solution with the following composition was obtained as a coating agent for forming a metal oxide film according to the embodiment:

| | | |
|---|---|---|
| Titanium(IV) tetraisopropoxide | 59.2 | mL |
| Ethyl protocatechuate | 72.9 | g |
| N,N,2-Trimethylpropionamide | 250 | mL |
| Ethyl lactate | 500 | mL |

### <Step 2>

AS Step 2, coating treatment is performed. Specifically, the coating agent for forming a metal oxide film obtained in Step 1 is coated on the surface of a substrate 1 made of borosilicate glass by the spin coating method, etc., and a coating film 2 is formed (see FIG. 2(A)).

### <Step 3>

As Step 3, curing treatment is performed. The curing treatment is, for example, heat treatment, and can be performed using a hot plate. The temperature of heat treatment is preferably 250 to 550° C., and the time of heat treatment is preferably 10 to 120 minutes. As shown in FIG. 2(B), by heat treatment, the solvent is evaporated and the coating film 2 is cured to become a metal oxide film 3.

### Second Embodiment

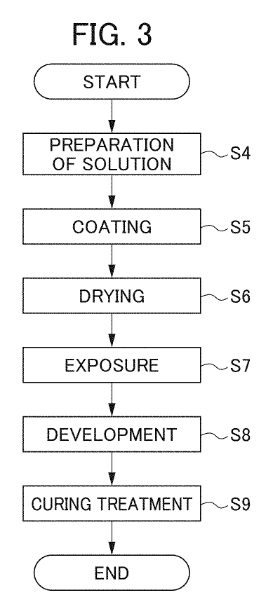

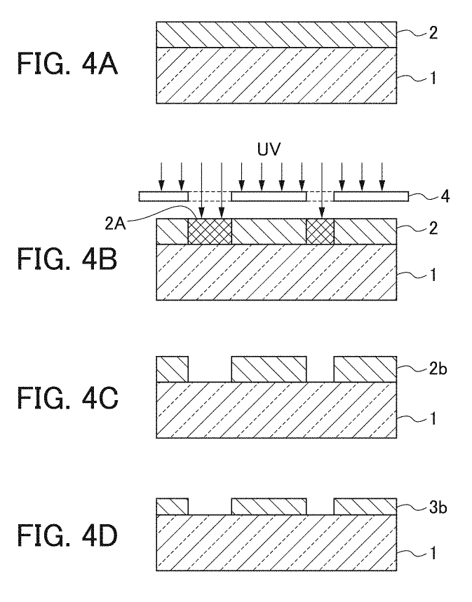

FIG. 3 is a flow chart showing a method for forming a metal oxide film pattern according to the second embodiment. FIG. 4 is a section view for describing a method for forming a metal oxide film according to the second embodiment.

### <Step 4>

In Step 4, a solution which becomes a coating agent is prepared. As the coating agent, a solution containing a solvent, a metal, a ligand compound, and a photosensitive compound may be prepared. As mentioned above, the solvent is a solvent containing a compound (A) represented by formula (1), and particularly N,N,2-trimethylpropionamide or N,N,N′,N′-tetramethylurea is preferable. The metal is a metal selected from Mg, Ca, Sr, Ba, Sc, Y, La-Lu, Ti, Zr, Hf, Nb, Ta, Mo, W, Zn, Al, In, Si, Ge, Sn, Cu, Fe, Co, Ni, Pd, Au, or Pt, or the like, and an organic compound including a metal may be used. As the photosensitive compound, a compound of NQD ester may be used.

By Step 4, a solution with the following composition was obtained as a coating agent for forming a metal oxide film (for pattern formation) according to the embodiment:

| | | |
|---|---|---|
| Titanium(IV) tetraisopropoxide | 59.2 | mL |
| Ethyl protocatechuate | 72.9 | g |
| N,N,2-trimethylpropionamide | 250 | mL |
| Ethyl lactate | 500 | mL |

| | |
|---|---|
| NQD ester | 0.1 mmol/L as an |
| | NQD group |

### <Step 5>

As Step 5, coating treatment is performed. Specifically, the coating agent for forming a metal oxide film obtained in Step 4 is coated on the surface of a substrate 1 made of borosilicate glass by the spin coating method, etc., and a coating film 2 is formed.

### <Step 6>

As Step 6, drying treatment is performed. The metal of the coating film 2 forms a stable metal complex. Thus, by drying treatment at 80 to 110° C. for 1 to 50 minutes, the solvent in the coating film 2 is evaporated.

### <Step 7>

As Step 7, a patterning step (exposure step) is performed. As shown in FIG. 4(B), when pattern exposure is performed via a photomask 4 by, for example, a light source such as a mercury vapor lamp, an exposure region 2A is formed. The exposure region 2A is changed into a state in which it is easily soluble in an alkaline developing solution.

### <Step 8>

As Step 8, a patterning step (development step) is performed. As shown in FIG. 4(C), when development is performed using an alkaline developing solution, the exposure region 2A is dissolved, and the coating film 2 is patterned (coating film 2b).

### <Step 9>

As Step 9, curing treatment is performed. As shown in FIG. 4(D), when heat curing treatment is performed at 250 to 550° C. for 10 to 120 minutes, the metal complex in the coating film 2b is degraded, and the coating film 2b becomes a metal oxide film 3b. As a result, a metal oxide film pattern is formed.

### Third Embodiment

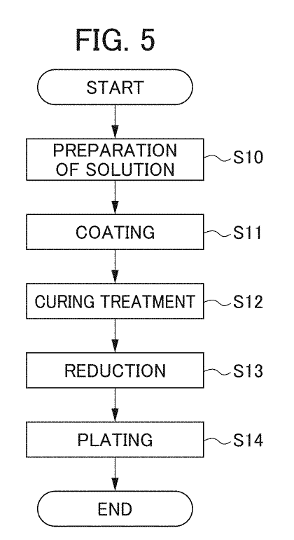

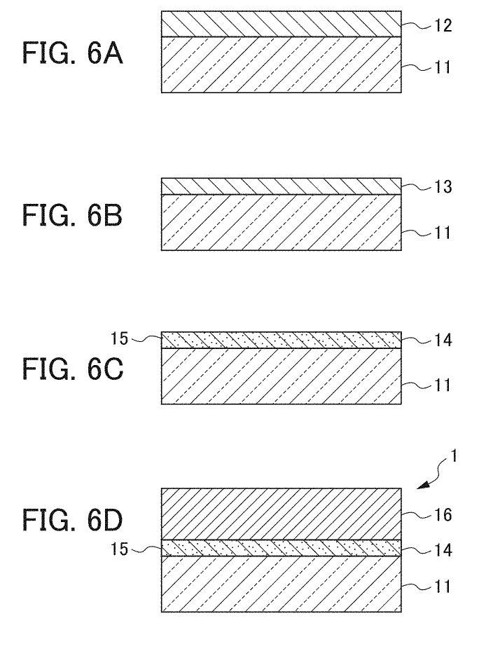

FIG. 5 is a flow chart showing a method for forming electroless plating according to the third embodiment. FIG. 6 is a section view for describing a method for forming electroless plating according to the third embodiment.

### <Step 10>

In Step 10, a catalytic solution for forming a catalytic surface is prepared first. The catalytic solution includes an organic compound of the first metal M1 which is not a catalyst in the electroless plating reaction and a compound of the second metal M2 which is a catalyst in the electroless plating reaction.

As the first metal Ml, Mg, Ca, Sr, Ba, Sc, Y, La-Lu, Ti, Zr, Hf, Nb, Ta, Mo, W, Zn, Al, Si, or Sn may be used. As the second metal M2, Ru, Co, Rh, Ni, Pt, Cu, Ag, or Au may be used. Pd, which is frequently used as a catalyst for electroless plating, is a metal that is not suitably used in this embodiment in terms of biocompatibility and cost. However, Pd may be used.

For example, when titanium (Ti) is selected as the first metal Ml, titanium alkoxide represented by titanium tetraisopropoxide may be used as an organic compound. Examples of the titanium alkoxide include titanium tetraisopropoxide, tetrabutoxytitanium, tetraethoxytitanium, alkoxide composed of a condensate such as a dimer, a trimer, and a tetramer thereof, a chelate such as titanyl bisacetylacetonate, dibutoxytitanium acetylacetonate, and isopropoxytitanium triethanolaminate, and an organic salt such as titanium stearate and titanium octylate. These titanium organic compounds are liquids or solids at room temperature.

Meanwhile, when gold (Au) is selected as the second metal M2, an Au inorganic salt represented by sodium chloroaurate may be as the compound. Examples of the Au inorganic salt include chloroauric acid, gold bromide, tetrachloro gold, gold sulfite, gold hydroxide, sodium hydroxide aurate (Au(OH)₄Na), acetic acid gold, a tiopronin-gold (I) complex, or a sodium salt or potassium salt thereof.

Meanwhile, when silver (Ag) is selected as the second metal M2, an Ag inorganic salt represented by silver nitrate may be used as the compound. Examples of the Ag inorganic salt include silver chloride, silver bromide, silver acetate, silver sulfate, or silver carbonate.

When copper (Cu) is selected as the second metal M2, a metal ion-soluble organic solvent represented by 2-methoxyethoxyacetic acid is preferably included to improve the solubility of a Cu ion.

In the third embodiment, a combination of Ti as the first metal M1, Cu as the second metal M2, and Cu as the fourth metal M4 is a preferable combination in terms of the fact that electroless copper plating can be formed without using Pd.

As a catalytic solution according to the embodiment, a Ti—Au solution with the following composition was prepared:

| | | |
|---|---|---|
| Titanium(IV) tetraisopropoxide: Ti (OⁱPr)₄ | 18 | mmol |
| 4-(2-Nitrobenzyloxycarbonyl)catechol ligand | 36 | mmol |
| N,N,2-Trimethylpropionamide | 80 | mL |
| Sodium chloroaurate dihydrate | 2 | mmol |
| Water | 1 | mL |

### <Step 11>

As shown in FIG. 6(A), the catalytic solution is coated on a substrate 11 made of borosilicate glass (TEMPAX: manufactured by SCHOTT) by the spin coating method, and a coating film 12 is formed.

### <Step 12>

As Step 12, curing treatment of a coating film 12 is performed. The curing treatment is, for example, heat treatment, and is preferably performed at 170° C. for 60 minutes using a hot plate. As shown in FIG. 6(B), by heat treatment, the solvent is evaporated and the coating film 12 is cured to become a catalyst precursor film 13. Curing is a reaction in which an organic compound (titanium tetraisopropoxide) of the first metal is degraded to become a metal oxide (titanium oxide). Titanium oxide produced by heat treatment at 170° C. preferably does not have a photocatalytic and highly crystalline structure but is non-photocatalytic amorphous. The temperature of heat treatment is appropriately selected in the range of 100° C. to 400° C.

The catalyst precursor film 13 has extremely high adhesiveness to the substrate 11 since an oxide of the first metal has a function as an inorganic binder. The catalyst precursor film 13 is preferably porous with a large specific surface area. By gas generated by evaporation of the solvent and degradation reaction of an organic compound of the first metal, etc., it is possible to make the catalyst precursor film 13 be porous.

### <Step 13>

As Step 13, the catalyst precursor film 13 is preferably immersed in an aqueous solution (50° C.) containing 2 g/L of sodium borohydride (SBH), which is a reductant, for 2 minutes. As the reductant, hypophosphorous acid, hydrazine, borohydride, dimethylamine borane, tetrahydroborate, or the like can be used.

By reduction treatment, the second metal M2 in an ionic state is reduced to a metal fine particle 15 having a catalytic function. In reduction treatment using a water-soluble reductant, an oxide of the second metal, which is a noble metal that becomes an electroless plating catalyst, is reduced, while an oxide of the first metal such as titanium oxide is not reduced by the above-mentioned reductant and remains as an oxide.

As shown in FIG. 6(C), the catalyst precursor film 13 becomes a catalytic membrane 14 in a state in which an Au fine particle having a catalytic function is supported on an inorganic oxide layer composed of titanium oxide. In other words, a catalytic membrane 14 in which a fine particle of the second metal, which becomes a catalyst in the electroless plating reaction, is supported on an inorganic oxide layer of the first metal, which does not become a catalyst in the electroless plating reaction, is formed.

The porous catalyst precursor film 13 has a large specific surface area, and many ions of the second metal are exposed on the surface. Since many ions of the second metal are reduced to the metal fine particle 15, the catalytic membrane 14 prepared from the porous catalyst precursor film 13 has catalytic ability.

### <Step 14>

As shown in FIG. 6(D), when the substrate 11 on which the catalytic membrane 14 is formed is immersed in an electroless plating bath, an electroless plating film 16 composed of the third metal M3 is formed on the catalytic membrane 14. For the electroless plating bath, publicly known various compositions including an ion of the third metal M3 and a reductant can be used.

As the third metal M3, Ru, Co, Rh, Ni, Pt, Cu, Ag, or Au can be used. It is preferable that the second metal M2 is the same as the third metal M3.

When the electroless gold plating bath A exemplified below is used, the second metal M2 and the third metal M3 are Au.

<Plating bath A>

| Tiopronin-gold complex (tetramer) | 0.91 g/L | (0.5 g/L as gold) |
|---|---|---|
| Dipotassium salt of phosphoric acid | 15 g/L | |
| Nicotinic acid | 2.5 g/L | |
| 3-Mercapto-1,2,4-triazole | 2.5 g/L | |
| PEG1000 (Wako Pure Chemical | 0.05 g/L | (surfactant) |
| Industries, Ltd. Wako 1st Grade | | |
| (165-09085) | | |
| Ascorbic acid | 9 g/L | (reductant) |

| | |
|---|---|
| Bath temperature: | 70° C. |
| pH: | 6 (adjusted with potassium |
| | hydroxide and sulfuric acid) |

The electroless gold plating film 16 according to the third embodiment showed high adhesive strength. Electroless silver plating formed on the electroless gold plating film 16 using the second metal M2 and the third metal M3 as Ag also showed high adhesive strength almost equivalent to that of the electroless gold plating film 16.

### Fourth Embodiment

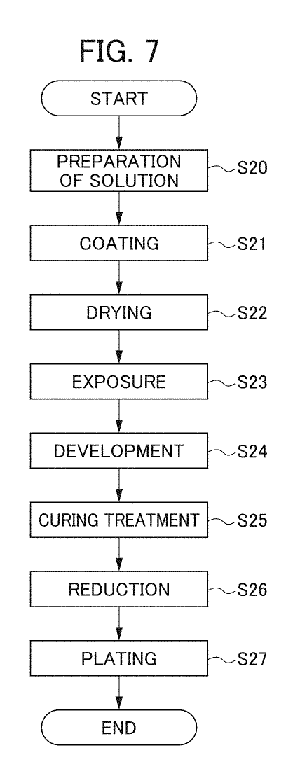

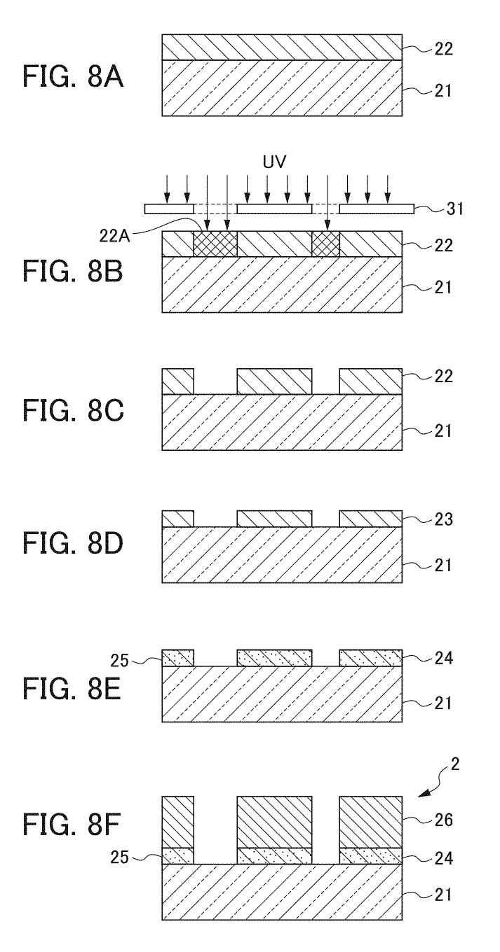

FIG. 7 is a flow chart showing a method for forming an electroless plating pattern according to the fourth embodiment. FIG. 8 is a section view for describing a method for forming an electroless plating pattern according to the fourth embodiment.

In the fourth embodiment, a combination of Ti as the first metal M1, Cu as the second metal M2, Pd as the third metal M3, and Cu or Ni as the fourth metal M4 is a preferable combination. As a result, the catalytic activity can be improved, and it is possible to increase the options of the fourth metal M4.

### <Step 20>

In Step 20, as a catalytic solution according to the fourth embodiment, a Ti—Cu solution with the following composition was prepared:

1) Photosensitive Ti—Cu (A-1)

| Ethyl protocatechuate (ligand) | 250 | mmol/L |
|---|---|---|
| Titanium(IV) tetraisopropoxide (M1) | 175 | mmol/L |
| Copper(II) acetate (M2) | 75 | mmol/L |
| Methoxyethoxyacetic acid | 110 | mmol/L |
| NQD ester | 100 mmol/L as an | |
| | NQD group | |
| N,N,2-Trimethylpropionamide | 250 | mL/L |
| γ-Butyrolactone | 80 | mL/L |
| Ethyl lactate | 400 | mL/L |
| Triethanolamine | 175 | mmol/L |

| | |
|---|---|
| Ethylene glycol silane oligomer | 87.5 mmol/L (as Si) |

### <Step 21>

As shown in FIG. 8(A), it is preferable that the catalytic solution is coated on a substrate 21 made of borosilicate glass (TEMPAX: manufactured by SCHOTT) by the spin coating method.

### <Step 22>

A metal of a coating film 22 forms a stable metal complex. Thus, heat treatment at 100° C. for 60 minutes is preferably drying treatment in which mainly the solvent is evaporated.

### <Step 23>

As Step 23, a patterning step (exposure step) is performed. As shown in FIG. 8(B), when pattern exposure is performed via a photomask 31 by a light source such as a mercury vapor lamp, an exposure region 22A is formed. The exposure region 22A is changed into a state in which it is easily soluble in an alkaline developing solution.

### <Step 24>

As Step 24, a patterning step (development step) is performed. As shown in FIG. 8(C), when development is performed using an alkaline developing solution, the exposure region 22A is dissolved, and the coating film 22 is patterned.

### <Step 25>

As Step 25, curing treatment is performed. As shown in FIG. 8(D), when heat curing treatment is performed at 300° C. for 60 minutes, the metal complex is degraded, and the coating film 22 becomes a catalyst precursor film 23. The catalyst precursor film 23 preferably has a structure in which a second metal M2 ion is dispersed in an inorganic binder composed of a first metal oxide.

### <Step 26>

As Step 26, the catalyst precursor film 23 is preferably immersed in an aqueous solution (50° C.) containing 2 g/L of sodium tetrahydroborate (SBH), which is a reductant, for 2 minutes. Then, as shown in FIG. 8(E), the catalyst precursor film 23 becomes a catalytic membrane 24 including a metal fine particle 25 in which the second metal M2 ion was reduced.

### <Step 27>

Using an electroless copper plating bath (PB-506: manufactured by Ebara-Udylite Co., Ltd.), an electroless copper plating film 26 is formed. In other words, a film of copper (Cu) as the third metal M3 is formed using the metal fine particle 25 composed of copper of the second metal M2 as a catalyst.

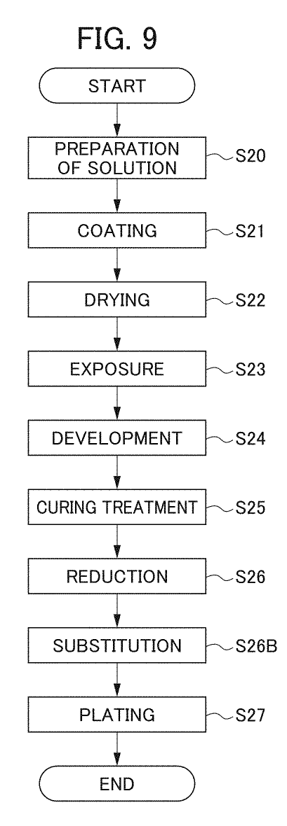

FIG. 9 is a flow chart showing a variation of a method for forming an electroless plating pattern according to the fourth embodiment. The method for forming an electroless plating pattern shown in FIG. 9 corresponds to the second production method for an electroless plating film as mentioned above, and includes a step of Step 26B in which the second metal in the reduced catalyst precursor film (catalytic membrane) is substituted by the third metal after reduction treatment in Step 26. Due to having the substitution step, it is possible to substitute by a metal which has high catalytic activity to a metal included in electroless plating. As a result, it is possible to form electroless plating having higher adhesiveness to a substrate.

The third production method for an electroless plating film as mentioned above is not illustrated, but preferably includes the steps of coating a catalytic solution containing an organic compound having the first metal (M1) on a substrate to form a coating film, firing the coating film, a step of imparting the third metal (M3) to make a catalytic material, and forming an electroless plating film containing the fourth metal (M4) on the catalytic material by electroless plating reaction. Firing of the coating film is preferably performed at 300 to 700° C. When the first metal is Ti, alkali treatment may be performed in such a manner that the coating film is immersed in a 1 M KOH aqueous solution at 50° C. for about 30 seconds to 3 minutes. Cleaner/conditioner (PB-102 manufactured by JCU Corporation) treatment may be performed. Reduction treatment may be performed to the catalytic surface to which the third metal (M3) was imparted. When an electric current is applied to the electroless plating film, thickening may be performed by electrolytic plating. When the adhesiveness of the electrolytic plating film is decreased, strong adhesiveness can be obtained by firing treatment. When the fourth metal is copper, the electroless plating film and the electrolytic plating film are preferably fired at 300 to 500° C. in terms of the fact that the 90° peel strength can be increased to 0.4 to 0.6 kN/m.

In the third production method for an electroless plating film, the first metal M1 may be Ti, the third metal M3 may be Pd, and the fourth metal M4 may be Cu or Ni. Meanwhile, a combination of Ti as the first metal Ml, Au or Pt as the third metal M3, and Au as the fourth metal M4, or a combination of Ti as the first metal Ml, Pt as the third metal M3, and Pt as the fourth metal M4 is a preferable combination in terms of the fact that electroless copper plating which is excellent in biocompatibility can be formed without using Pd.

An example of a formulation of a photosensitive metal complex solution is shown below. The photosensitive metal complex solutions of the following 1) to 8) are preferably used for the above-mentioned first production method and second production method. The photosensitive metal complex solutions of 9) to 10) are preferably used for the above-mentioned third production method.

1) Photosensitive Ti—Cu (A-1)

| Ethyl protocatechuate (ligand) | 250 | mmol/L |
|---|---|---|
| Titanium(IV) tetraisopropoxide(M1) | 175 | mmol/L |
| Copper(II) acetate (M2) | 75 | mmol/L |
| Methoxyethoxyacetic acid | 110 | mmol/L |
| NQD ester | 100 mmol/L as an | |
| | NQD group | |
| N,N,2-Trimethylpropionamide | 250 | mL/L |
| γ-Butyrolactone | 80 | mL/L |
| Ethyl lactate | 400 | mL/L |
| Triethanolamine | 175 | mmol/L |

| | |
|---|---|
| Ethylene glycol silane oligomer | 87.5 mmol/L (as Si) |

2) Photosensitive Ti—Cu (A-2)

| Ethyl protocatechuate (ligand) | 385 | mmol/L |
|---|---|---|
| Titanium(IV) tetraisopropoxide (M1) | 175 | mmol/L |
| Copper(II) acetate (M2) | 75 | mmol/L |
| NQD ester | 100 mmol/L as an | |
| | NQD group | |
| N,N,2-Trimethylpropionamide | 250 | mL/L |
| γ-Butyrolactone | 80 | mL/L |
| Ethyl lactate | 400 | mL/L |
| Triethanolamine | 87.5 | mmol/L |
| 3-(N,N-Dimethylamino)propyltriethoxysilane | 87.5 | mmol/L |

3) Photosensitive Ti—Cu (B)

| 4-Cyanocatechol (ligand) | 250 | mmol/L |
|---|---|---|
| Titanium(IV) tetraisopropoxide (M1) | 175 | mmol/L |
| Copper(II) acetate (M2) | 75 | mmol/L |
| NQD ester | 100 mmol/L as an | |
| | NQD group | |
| N,N,2-Trimethylpropionamide | 250 | mL/L |
| γ-Butyrolactone | 80 | mL/L |
| Ethyl lactate | 400 | mL/L |
| Triethanolamine | 175 | mmol/L |

| | |
|---|---|
| Ethylene glycol silane oligomer | 87.5 mmol/L (as Si) |

4) Photosensitive Ti—Cu (C)

| 4-Methylcatechol (ligand) | 250 | mmol/L |
|---|---|---|
| Titanium(IV) tetraisopropoxide (M1) | 175 | mmol/L |
| Copper(II) acetate (M2) | 75 | mmol/L |
| NQD ester | 100 mmol/L as an | |
| | NQD group | |
| N,N,2-Trimethylpropionamide | 250 | mL/L |
| γ-Butyrolactone | 80 | mL/L |
| Ethyl lactate | 400 | mL/L |
| Triethanolamine | 175 | mmol/L |

| | |
|---|---|
| Ethylene glycol silane oligomer | 87.5 mmol/L (as Si) |

5) Photosensitive Ti—Cu (D)

| Ethyl protocatechuate (ligand) | 250 | mmol/L |
|---|---|---|
| Titanium(IV) tetraisopropoxide (M1) | 175 | mmol/L |
| Copper(II) acetate (M2) | 75 | mmol/L |
| NQD ester | 100 mmol/L as an | |
| | NQD group | |
| N,N,2-Trimethylpropionamide | 250 | mL/L |
| γ-Butyrolactone | 80 | mL/L |
| Ethyl lactate | 400 | mL/L |

6) Photosensitive Nb—Cu

| Ethyl protocatechuate (ligand) | 250 | mmol/L |
|---|---|---|
| Niobium(V) pentaethoxide (M1) | 175 | mmol/L |
| Copper(II) acetate (M2) | 75 | mmol/L |
| NQD ester | 100 mmol/L as an | |
| | NQD group | |
| N,N,2-Trimethylpropionamide | 250 | mL/L |
| γ-Butyrolactone | 80 | mL/L |
| Ethyl lactate | 400 | mL/L |
| Triethanolamine | 175 | mmol/L |

| | |
|---|---|
| Ethylene glycol silane oligomer | 87.5 mmol/L (as Si) |

7) Photosensitive Ti—Ni

| Ethyl protocatechuate (ligand) | 250 | mmol/L |
|---|---|---|
| Titanium(IV) tetraisopropoxide (M1) | 175 | mmol/L |
| Nickel(II) acetate (M2) | 75 | mmol/L |
| NQD ester | 100 mmol/L as an | |
| | NQD group | |
| N,N,2-Trimethylpropionamide | 250 | mL/L |
| γ-Butyrolactone | 80 | mL/L |
| Ethyl lactate | 400 | mL/L |
| Triethanolamine | 175 | mmol/L |

| | |
|---|---|
| Ethylene glycol silane oligomer | 87.5 mmol/L (as Si) |

8) Photosensitive Ti—Co

| Ethyl protocatechuate (ligand) | 250 | mmol/L |
|---|---|---|
| Titanium(IV) tetraisopropoxide (M1) | 175 | mmol/L |
| Cobalt(II) acetate (M2) | 75 | mmol/L |
| NQD ester | 100 mmol/L as an | |
| | NQD group | |
| N,N,2-Trimethylpropionamide | 250 | mL/L |
| γ-Butyrolactone | 80 | mL/L |
| Ethyl lactate | 400 | mL/L |
| Triethanolamine | 175 | mmol/L |

| | |
|---|---|
| Ethylene glycol silane oligomer | 87.5 mmol/L (as Si) |

9) Photosensitive Ti

| Ethyl protocatechuate (ligand) | 250 | mmol/L |
|---|---|---|
| Titanium(IV) tetraisopropoxide (M1) | 250 | mmol/L |
| NQD ester | 100 mmol/L as an | |
| | NQD group | |
| N,N,2-Trimethylpropionamide | 250 | mL/L |
| γ-Butyrolactone | 80 | mL/L |
| Ethyl lactate | 400 | mL/L |
| Triethanolamine | 175 | mmol/L |

| | |
|---|---|
| Ethylene glycol silane oligomer | 87.5 mmol/L (as Si) |

10) Photosensitive Nb

| Ethyl protocatechuate (ligand) | 300 | mmol/L |
|---|---|---|
| Niobium(V) pentaethoxide (M1) | 250 | mmol/L |
| NQD ester | 100 mmol/L as an | |
| | NQD group | |
| N,N,2-Trimethylpropionamide | 250 | mL/L |
| γ-Butyrolactone | 80 | mL/L |
| Ethyl lactate | 400 | mL/L |
| Triethanolamine | 175 | mmol/L |

| | |
|---|---|
| Ethylene glycol silane oligomer | 87.5 mmol/L (as Si) |

In the photosensitive metal complex solution of 1) to 10) exemplified above, the N,N,2-trimethylpropionamide may be another solvent which is the compound (A) represented by formula (1) mentioned above. Adjustment may be performed with the amount of ethyl lactate so that the entire volume of the photosensitive metal complex solutions of 1) to 10) is 1 L. Ethyl protocatechuate may be 200 to 500 mmol/L. NQD ester may be 90 to 120 mmol/L as an NQD group. NQD ester may be a compound (40 g/L) in which all hydroxyl groups of 4,4′-{1-[4-[2-(4-hydroxyphenyl)-2-propyl]phenyl]ethylidene}bisphenol are substituted by NQD groups or NQD3-dopamine(N,O,O-tris-(1,2-naphthoquinone-2-diazide-5-sulfonato)-2-(3,4-dihydroxyphenyl)ethylamine) (30 g/L).

### EXAMPLES

Examples of the present invention will be described below. The present invention is not limited to the descriptions of the following Examples.

### Example 1

### 1. Film Formation Treatment:

A photosensitive metal complex coating solution (photosensitive Ti-Cu (A-1)) is spin coated on a substrate (TEMPAX manufactured by Schott) such that the metal oxide film is about 45 nm, and dried at 100° C. for 10 minutes to form a photosensitive metal complex film. The through VIA-processed glass was dip coated in a solution in which the volume ratio of methyl ethyl ketone:photosensitive Ti—Cu (A-1) was 4:1, thereby forming a photosensitive metal complex film. In N,N,2-trimethylpropionamide, which is a solvent included in the photosensitive Ti—Cu (A-1), the boiling point is 175° C., the surface tension is 31.9 mN/m, and the vapor pressure is 9 kPa at 100° C. The NQD ester included in the photosensitive Ti—Cu (A-1) is a compound in which all hydroxyl groups of 4,4′-{1-[4-[2-(4-hydroxyphenyl)-2-propyl]phenyl]ethylidene}bisphenol are substituted by NQD groups.

### 2. Pattern Formation:

Using a parallel aligner (Multilight, manufactured by USHIO INC.) and a light source (USH-250BY/D-z1, manufactured by USHIO INC., 5 mW/cm² at λ=313 nm), the exposure dose of 150 mJ/cm² was irradiated. After exposure, development was performed for 30 seconds using a 0.25% tetraethylammonium hydroxide aqueous solution.

### 3. Firing Ttreatment:

The patterned substrate and processed glass were fired in an electric furnace at 400° C. for 1 hour.

### 4. Reduction Treatment:

The fired and patterned substrate and processed glass were immersed in 2 g/L of a NaBH4 (pH 12) aqueous solution at 30° C. for 5 minutes, thereby reducing a Cu oxide in the metal oxide film to metal Cu.

### 5. Substitution Treatment (Enhancement of Catalytic Activity):

The patterned substrate and processed glass after the reduction treatment were immerse in 300 mg/L of a PdCl₂ aqueous solution at 30° C. for 5 minutes, thereby substituting the metal Cu by metal Pd.

### 6. Electroless Copper Plating:

The patterned substrate and processed glass after the substitution treatment were immersed in an electroless copper plating solution (PB-506, manufactured by JCU Corporation), thereby precipitating a Cu film of 0.15 μm on the Ti oxide/metal Cu/metal Pd pattern film. After electroless copper, drying was performed at 120° C. for 10 minutes. As a result, electroless copper plating was formed.

### 7. Evaluation of Adhesive Force:

To evaluate the adhesive force of the plating film, a step of exposure/development was omitted, and a copper foil of 15 μm was formed using electrolytic copper plating (CU BRITE 21, manufactured by JCU Corporation), firing was performed in a nitrogen furnace at 400° C. for 1 hour, and then a 90° peel test was performed (JIS standard H8630). The adhesive force was 0.5 kN/m and excellent.

### Comparative Example 1

A plating film was formed in the same manner as in Example 1, except that N,N,2-trimethylpropionamide was substituted by NMP (boiling point of 202° C., surface tension of 40.79, and vapor pressure of 0.04 kPa at 20° C.) regarding a solvent in the photosensitive metal complex coating solution.

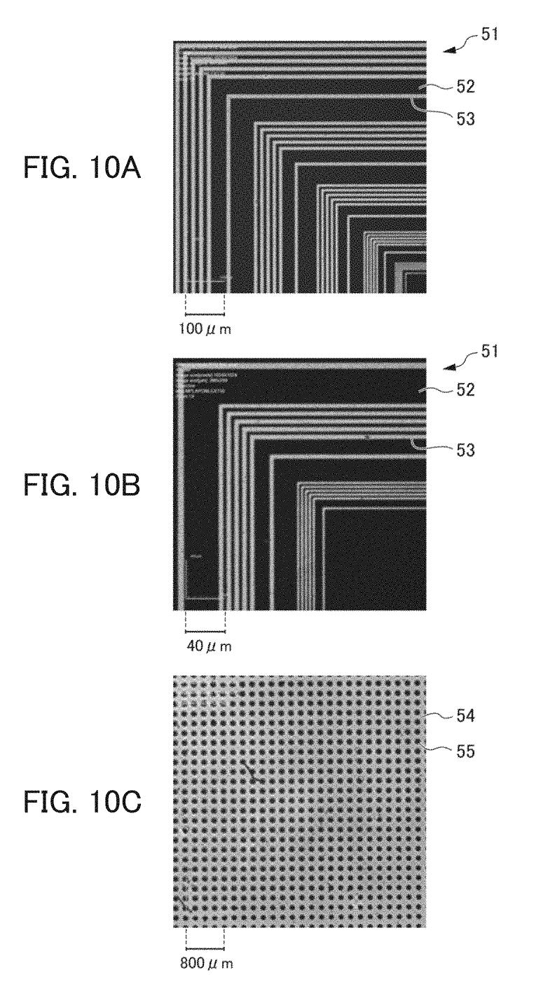

FIG. 10 is a photomicrograph showing that a substrate and a through processed glass were coated with the coating agent for forming a metal oxide film according to Example 1. As shown in FIGS. 10(a) and (b), in Example 1, a pattern was finely formed, and also conformally formed on the through processed glass as shown in FIG. 10(c).

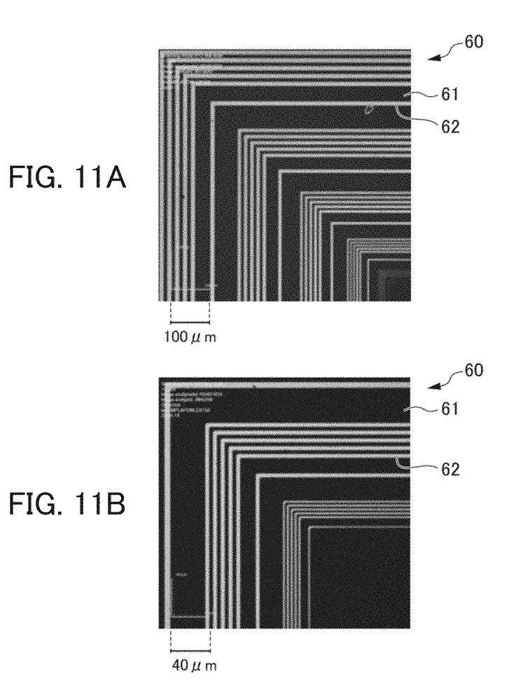

FIG. 11 is a photomicrograph showing that a substrate was coated with the coating agent for forming a metal oxide film according to Comparative Example 1. When NMP was used, a pattern was formed as shown in FIGS. 11(a) and (b). However, a plating film could not be formed on the surface of the through processed glass.

### EXPLANATION OF REFERENCE NUMERALS

1, 11, 21 Substrate (Base)

2, 12, 22 Coating film

3, 13 Metal oxide film

3b, 23 Metal oxide film pattern

4, 31 Photomask

14 Catalytic surface

16 Electroless plating

1. A coating agent for forming a metal oxide film, comprising a solvent and a metal, wherein the solvent comprises a compound (A) represented by the following formula (1): 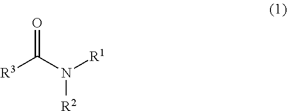
wherein, in formula (1), R¹ and R² each independently represent an alkyl group having 1 to 3 carbon atoms; and R³ represents a group represented by the following formula (1-1) or the following formula (1-2): 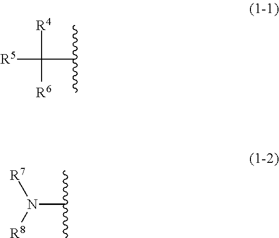
wherein, in formula (1-1), R⁴ represents a hydrogen atom or a hydroxyl group; and R⁵ and R⁶ each independently represent an alkyl group having 1 to 3 carbon atoms, and wherein, in formula (1-2), R⁷ and R⁸ each independently represent a hydrogen atom or an alkyl group having 1 to 3 carbon atoms.

2. A coating agent for forming a metal oxide film, comprising a solvent and a metal, wherein the boiling point of the solvent is 150 to 190° C., the surface tension at 20° C. is 25 to 35 mN/m, and the vapor pressure at 100° C. is 5 to 15 kPa.

3. The coating agent according to claim 1, wherein the metal is a metal having conductivity.

4. The coating agent according to claim 1, further comprising a ligand compound.

5. The coating agent according to claim 1, further comprising a photosensitive compound.

6. The coating agent according to claim 1, wherein the compound (A) is N,N,2-trimethylpropionamide or N,N,N′,N′-tetramethylurea.

7. A method for producing a substrate having a metal oxide film, comprising coating the coating agent according to claim 1 on a substrate and heating to form a metal oxide film.

8. The production method according to claim 7, wherein the substrate comprises an interposer substrate with micron scale holes, and the micron scale hole surfaces are covered with a metal oxide film.

9. The production method according to claim 7, which is used for production of a plated substrate.

10. The coating agent according to claim 2, wherein the metal is a metal having conductivity.

11. The coating agent according to claim 2, further comprising a ligand compound.

12. The coating agent according to claim 2, further comprising a photosensitive compound.

13. The coating agent according to claim 2, wherein the compound (A) is N,N,2-trimethylpropionamide or N,N,N′,N′-tetramethylurea.

14. A method for producing a substrate having a metal oxide film, comprising coating the coating agent according to claim 2 on a substrate and heating to form a metal oxide film.

15. The production method according to claim 14, wherein the substrate comprises an interposer substrate with micron scale holes, and the micron scale hole surfaces are covered with a metal oxide film.

16. The production method according to claim 14, which is used for production of a plated substrate.

17. A method of forming a metal oxide film, comprising coating and heating the coating agent according to claim 1 to form a metal oxide film.

18. A method of forming a metal oxide film, comprising coating and heating the coating agent according to claim 2 to form a metal oxide film.
